(19) United States
(12) Patent Application Publication
(10) Pub. No.: US 2022/0126876 A1
(43) Pub. Date: Apr. 28, 2022

(54) VEHICLE OPERATION USING BEHAVIORAL RULE CHECKS

(71) Applicant: Motional AD LLC, Boston, MA (US)

(72) Inventors: Radboud Duintjer Tebbens, Winchester, MA (US); Calin Belta, Sherborn, MA (US); Hsun-Hsien Chang, Brookline, MA (US); Amitai Bin-Nun, Silver Spring, MD (US); Anne Collin, Cambridge, MA (US); Noushin Mehdipour, Boston, MA (US); Wei Xiao, Boston, MA (US)

(21) Appl. No.: 17/497,245

(22) Filed: Oct. 8, 2021

Related U.S. Application Data
(60) Provisional application No. 63/105,006, filed on Oct. 23, 2020.
(60) Provisional application No. 63/216,953, filed on Jun. 30, 2021.

(51) Int. Cl. B60W 60/00

(52) U.S. Cl. CPC B60W 60/0027; B60W 2540/18; B60W 2520/10; B60W 2520/12; B60W 2520/105; B60W 2520/125; B60W 2554/404; B60W 2420/52; B60W 2420/42; B60W 2420/40; B60W 2420/54; B60W 2554/801; B60W 2520/06

(57) ABSTRACT

Methods for vehicle operation using behavioral rule checks include receiving first sensor data from first sensors and second sensor data from second sensors of the vehicle. The first sensor data represents operation of the vehicle in accordance with a first trajectory. The second sensor data represents at least one object. It is determined that the first trajectory violates a first behavioral rule of operation based on the first sensor data and the second sensor data. The first behavioral rule has a first priority. Multiple alternative trajectories are generated using control barrier functions. A second trajectory is identified that violates a second behavioral rule having a second priority less than the first priority. Responsive to identifying the second trajectory, a message is transmitted to a control circuit of the vehicle to operate the vehicle based on the second trajectory.

### CROSS-REFERENCE TO RELATED APPLICATIONS

This application claims priority to U.S. Provisional Application No. 63/105,006, filed Oct. 23, 2020, and U.S. Provisional Application No. 63/216,953, filed Jun. 30, 2021, the entire contents of each of which are incorporated herein by reference.

### FIELD OF THE INVENTION

This description relates generally to operation of vehicles and specifically to vehicle operation using behavioral rule checks.

### BACKGROUND

Operation of a vehicle from an initial location to a final destination often requires a user or a vehicle's decision-making system to select a route through a road network from the initial location to a final destination. The route may involve meeting objectives, such as not exceeding a maximum driving time. Moreover, vehicles may be required to meet complex specifications imposed by traffic laws and the cultural expectations of driving behavior. Thus, operation of an autonomous vehicle can require many decisions, making traditional algorithms for autonomous driving impractical.

### SUMMARY

Methods, systems, and apparatus for vehicle operation using behavioral rule checks are disclosed. In an embodiment, at least one processor receives first sensor data from a first set of sensors of a vehicle and second sensor data from a second set of sensors of the vehicle. The first sensor data represents operation of the vehicle in accordance with a first trajectory. The second sensor data represents at least one object. The least one processor determines that the first trajectory violates a first behavioral rule of a hierarchical set of rules of operation of the vehicle based on the first sensor data and the second sensor data. The first behavioral rule has a first priority. The at least one processor generates multiple alternative trajectories for the vehicle based on the first sensor data and the second sensor data. The at least one processor identifies a second trajectory from the multiple alternative trajectories. The second trajectory violates a second behavioral rule of the hierarchical set of rules. The second behavioral rule has a second priority less than the first priority. Responsive to identifying the second trajectory, the at least one processor transmits a message to a control circuit of the vehicle to operate the vehicle based on the second trajectory.

In an embodiment, the framework is a generally offline framework. In a generally offline framework, a pass/fail evaluation of trajectories is executed after-the-fact. A given trajectory is rejected if a controller producing trajectory that leads to less violation of the rule priority structure is found.

In an embodiment, the framework is a generally online framework. In a generally online framework, the vehicle has a limited sensing range that alters a hierarchical set of rules of operation of the vehicle. Control is generated using a receding horizon (model predictive control) approach.

In an embodiment, the at least one processor is located within a planning circuit of the vehicle. The at least one processor receives the first sensor data and the second sensor data during the operation of the vehicle.

In an embodiment, the at least one processor adjusts operation of a planning circuit of the vehicle based on the second trajectory. The at least one processor is located on a computer device external to the vehicle. The at least one processor receives the first sensor data and the second sensor data after the operation of the vehicle.

In an embodiment, the first set of sensors includes at least one of an accelerometer, a steering wheel angle sensor, a wheel sensor, or a brake sensor. The first sensor data includes at least one of a speed of the vehicle, an acceleration of the vehicle, a heading of the vehicle, an angular velocity of the vehicle, or a torque of the vehicle.

In an embodiment, the second set of sensors includes at least one of a LiDAR, a RADAR, a camera, a microphone, an infrared sensor, a sound navigation and ranging (SONAR) sensor, and the like.

In an embodiment, the second sensor data is at least one of an image of the at least one object, a speed of the at least one object, an acceleration of the at least one object, a lateral distance between the at least one object and the vehicle, or other kinematic data.

In an embodiment, the at least one processor selects the second trajectory from the multiple alternative trajectories using at least one of minimum-violation planning, model predictive control, or machine learning, the selecting based on the hierarchical plurality of rules.

In an embodiment, each behavioral rule of the hierarchical set of rules has a respective priority with respect to each other behavioral rule of the hierarchical set of rules. The respective priority represents a risk level of violating the each behavioral rule with respect to the each other behavioral rule.

In an embodiment, violating the first behavioral rule includes operating the vehicle such that a lateral distance between the vehicle and the at least one object decreases below a threshold lateral distance.

In an embodiment, violating the first behavioral rule includes operating the vehicle such that the vehicle exceeds a speed limit.

In an embodiment, violating the first behavioral rule includes operating the vehicle such that the vehicle stops before reaching a destination.

In an embodiment, violating the first behavioral rule includes operating the vehicle such that the vehicle collides with the at least one object.

In an embodiment, the at least one processor determines a path of the at least one object based on the second sensor data. Determining that the first trajectory violates the first behavioral rule is further based on the path of the at least one object.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 is a block diagram illustrating an example of an autonomous vehicle (AV) having autonomous capability, in accordance with one or more embodiments.

FIG. 2 is a block diagram illustrating an example “cloud” computing environment, in accordance with one or more embodiments.

FIG. 3 is a block diagram illustrating a computer system, in accordance with one or more embodiments.

FIG. 4 is a block diagram illustrating an example architecture for an AV, in accordance with one or more embodiments.

FIG. 5 is a block diagram illustrating an example of inputs and outputs that may be used by a perception module, in accordance with one or more embodiments.

FIG. 6 is a block diagram illustrating an example of a LiDAR system, in accordance with one or more embodiments.

FIG. 7 is a block diagram illustrating the LiDAR system in operation, in accordance with one or more embodiments.

FIG. 8 is a block diagram illustrating the operation of the LiDAR system in additional detail, in accordance with one or more embodiments.

FIG. 9 is a block diagram illustrating the relationships between inputs and outputs of a planning module, in accordance with one or more embodiments.

FIG. 10 illustrates a directed graph used in path planning, in accordance with one or more embodiments.

FIG. 11 is a block diagram illustrating the inputs and outputs of a control module, in accordance with one or more embodiments.

FIG. 12 is a block diagram illustrating the inputs, outputs, and components of a controller, in accordance with one or more embodiments.

FIG. 13A illustrates an example scenario for vehicle operation using behavioral rule checks, in accordance with one or more embodiments.

FIG. 13B illustrates an example hierarchical set of rules, in accordance with one or more embodiments.

FIG. 14 illustrates an example flow diagram for vehicle operation using behavioral rule checks, in accordance with one or more embodiments.

FIG. 15 illustrates an example flow diagram for vehicle operation using behavioral rule checks, in accordance with one or more embodiments.

FIG. 16 illustrates an example of performing behavioral rule checks for a vehicle, in accordance with one or more embodiments.

FIG. 17 illustrates an example flow diagram for vehicle operation using behavioral rule checks, in accordance with one or more embodiments.

FIG. 18 illustrates an example output of performing behavioral rule checks for a vehicle, in accordance with one or more embodiments.

FIG. 19 illustrates an example flow diagram for vehicle operation using behavioral rule checks, in accordance with one or more embodiments.

FIG. 20 illustrates an example hierarchical set of rules for vehicle operation using behavioral rule checks, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in an embodiment.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. System Overview
3. Autonomous Vehicle Architecture
4. Autonomous Vehicle Inputs
5. Autonomous Vehicle Planning
6. Autonomous Vehicle Control
7. Autonomous Vehicle Operation Using Behavioral Rule Checks

### General Overview

This document presents methods, systems, and apparatuses for vehicle operation using behavioral rule checking. Road safety is a leading public health issue with over 1 million global road traffic fatalities in 2020 and is currently the seventh leading cause of death in the United States by years of life lost. The embodiments disclosed herein implement rule-based checking to evaluate the performance of a machine driver, evaluate risk factors, and evaluate the trajectory generation capabilities of an AV system or of a subsystem, such as a motion planning module. The implementations of behavior-based driving assessment disclosed here are based on determining whether an alternative trajectory that could have resulted in fewer violations was available to an autonomous vehicle that violated particular rules. The rules derive from safety considerations, traffic laws, and commonly accepted best practices. Driving rule formulation is used to quantitatively evaluate how actual driving, by an automated system, matches desirable driving behaviors.

The advantages and benefits of the embodiments described herein include improved evaluation of driving performance for automated vehicle systems compared to traditional methods. Using the embodiments, specific autonomous driving behaviors can be evaluated more efficiently. The rule-based control approach implemented using control barrier functions can be used or automated “after-the-fact” optimal control evaluation as well as for execution on an autonomous vehicle for real-time evaluation as a trajectory checker. Because the implementations have reduced computational complexity, the embodiments disclosed can also be implemented in real time on an autonomous vehicle as a rule-based planner or controller.

Further advantages and benefits of the embodiments disclosed herein include consideration of alternative trajectories, such that unreasonable expectations are not enforced on the autonomous vehicle. Because rulebooks are scenario- and technology-agnostic, a rulebook can be used for numerous scenarios, different autonomous vehicle stack builds, different sensor configurations, and different planner algorithms. The embodiments disclosed render the autonomous vehicle implementation more scalable and obviate judgment calls by a test evaluator. Moreover, the embodiments can inform a variety of regulatory and standards processes, which are increasingly requiring specific AV behaviors, and to foster industry collaboration on defining good AV driving behaviors.

### System Overview

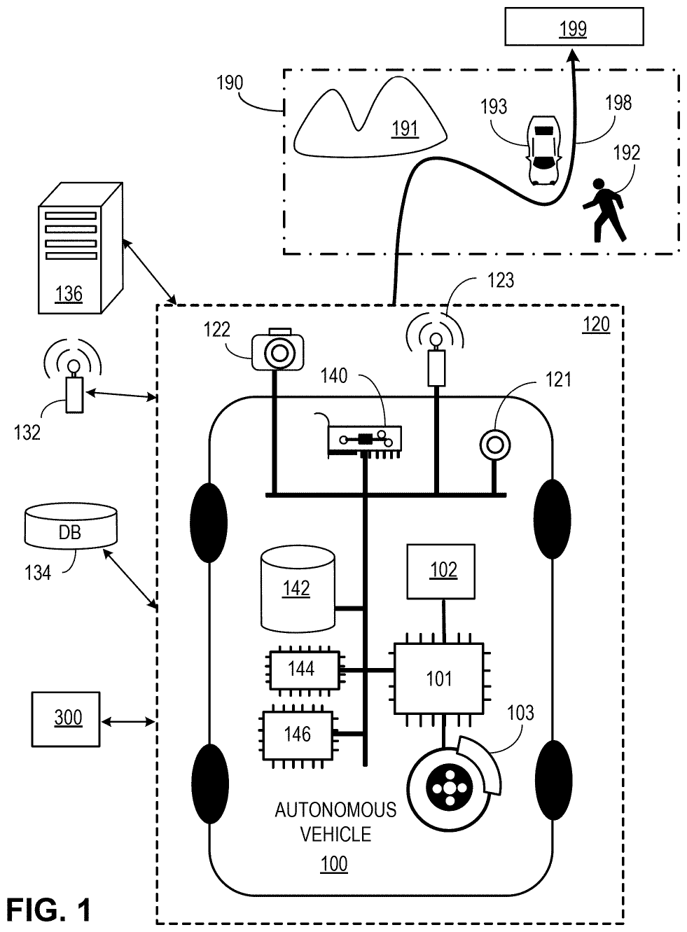

FIG. 1 is a block diagram illustrating an example of an autonomous vehicle 100 having autonomous capability, in accordance with one or more embodiments.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to operate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle and may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings or having two lanes between the lane markings. A lane could also be interpreted in the absence of lane markings. For example, a lane may be defined based on physical features of an environment, e.g., rocks and trees along a thoroughfare in a rural area.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “includes,” and/or “including,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

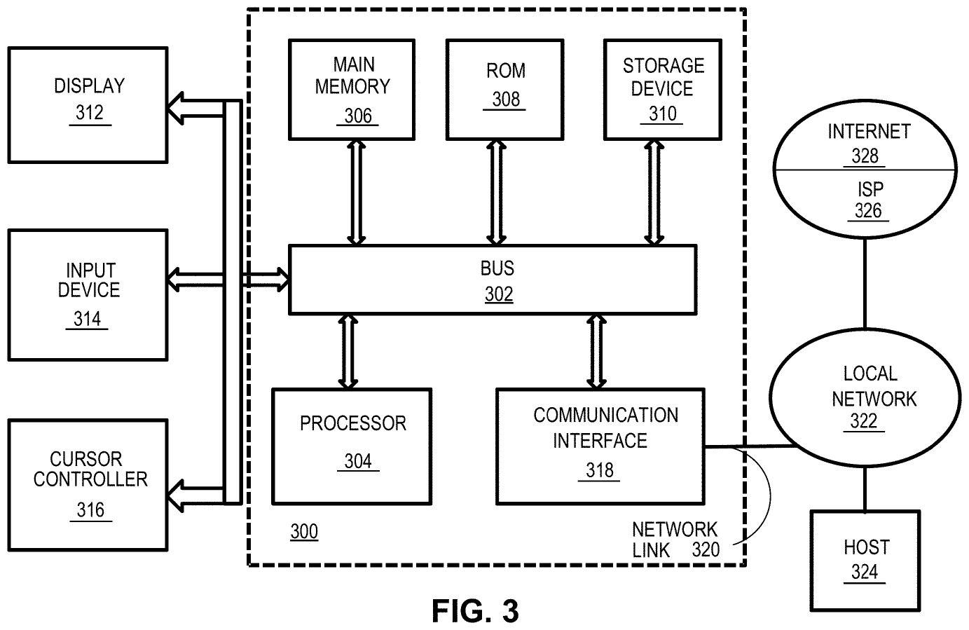

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear velocity and acceleration, angular velocity and acceleration, and heading (e.g., an orientation of the leading end of AV 100). Example of sensors 121 are GNSS, inertial measurement units (IMU) that measure both vehicle linear accelerations and angular rates, wheel sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in an embodiment, one or more other types of communication) is sometimes referred to as Vehicle-to-Everything (V2X) communication. V2X communication typically conforms to one or more communications standards for communication with, between, and among autonomous vehicles.

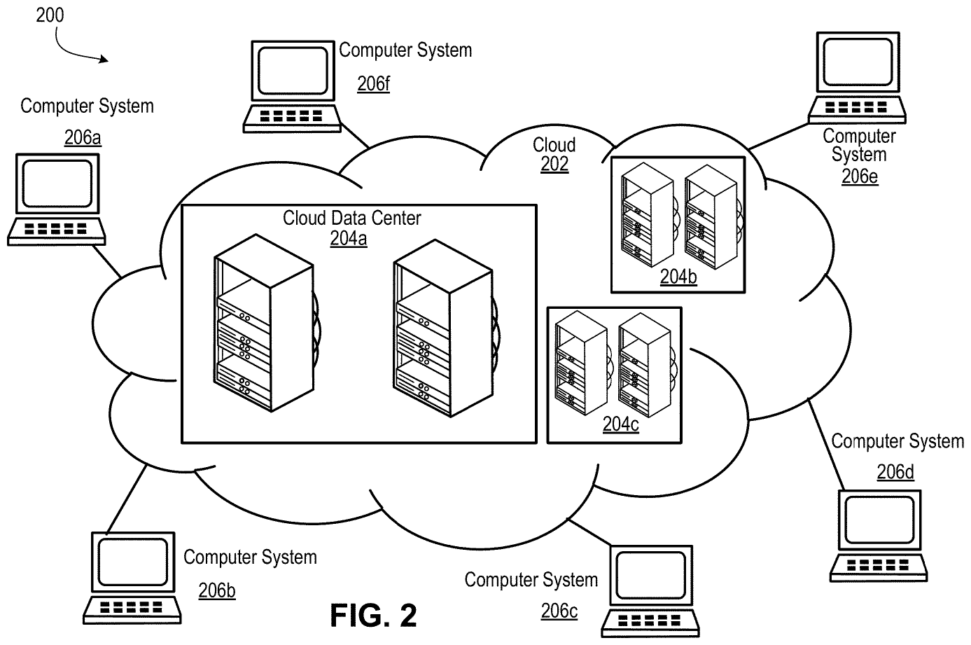

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In an embodiment, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

Example Cloud Computing Environment

FIG. 2 is a block diagram illustrating an example “cloud” computing environment, in accordance with one or more embodiments. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In an embodiment, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

Computer System

FIG. 3 is a block diagram illustrating a computer system 300, in accordance with one or more embodiments. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that include the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

Autonomous Vehicle Architecture

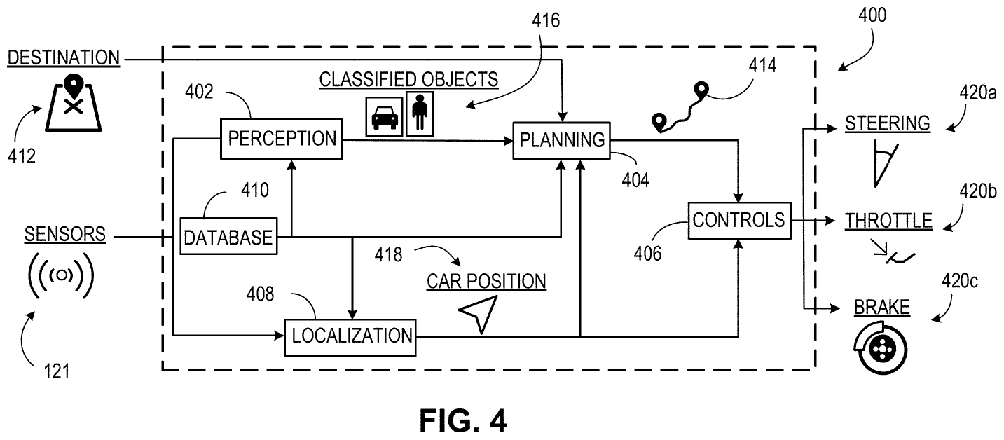

FIG. 4 is a block diagram illustrating an example architecture 400 for an autonomous vehicle (e.g., the AV 100 shown in FIG. 1), in accordance with one or more embodiments. The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In an embodiment, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a global navigation satellite system (GNSS) unit and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

Autonomous Vehicle Inputs

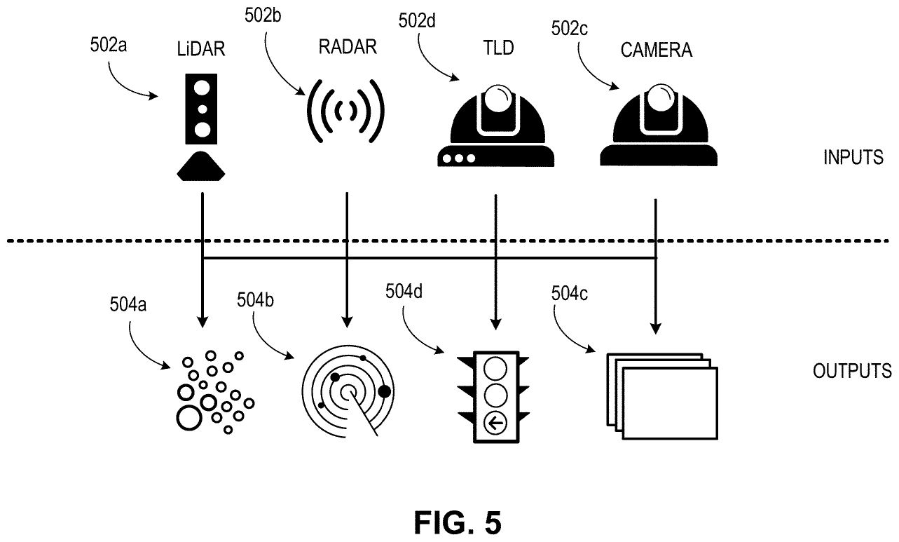

FIG. 5 is a block diagram illustrating an example of inputs 502a-d (e.g., sensors 121 shown in FIG. 1) and outputs 504a-d (e.g., sensor data) that is used by the perception module 402 (FIG. 4), in accordance with one or more embodiments. One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual operation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual operation information as possible, so that the AV 100 has access to all relevant operation information provided by these objects. For example, the viewing angle of the TLD system may be about 120 degrees or more.

In an embodiment, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In an embodiment, an early fusion technique is used. An early fusion technique is characterized by combining outputs before one or more data processing steps are applied to the combined output. In an embodiment, a late fusion technique is used. A late fusion technique is characterized by combining outputs after one or more data processing steps are applied to the individual outputs.

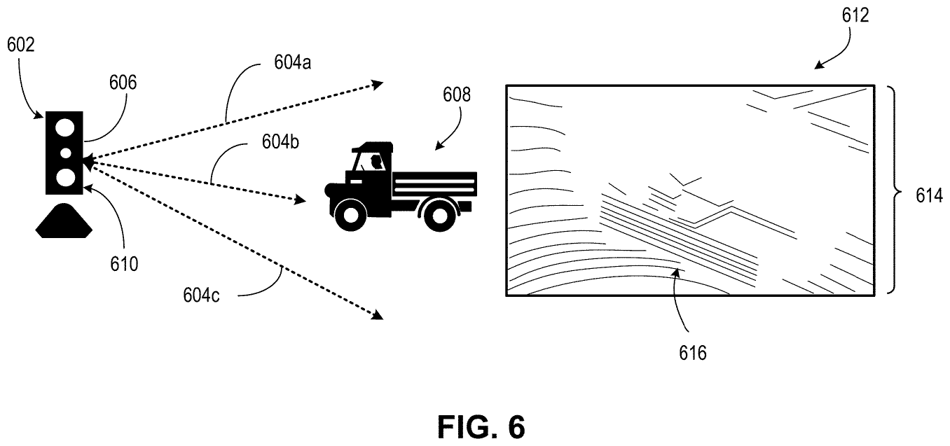

FIG. 6 is a block diagram illustrating an example of a LiDAR system 602 (e.g., the input 502a shown in FIG. 5), in accordance with one or more embodiments. The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

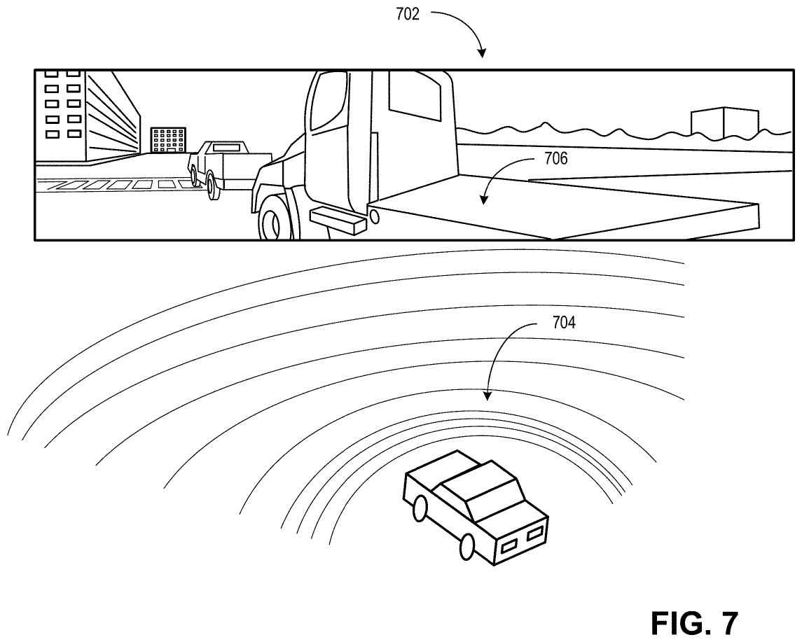

FIG. 7 is a block diagram illustrating the LiDAR system 602 in operation, in accordance with one or more embodiments. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

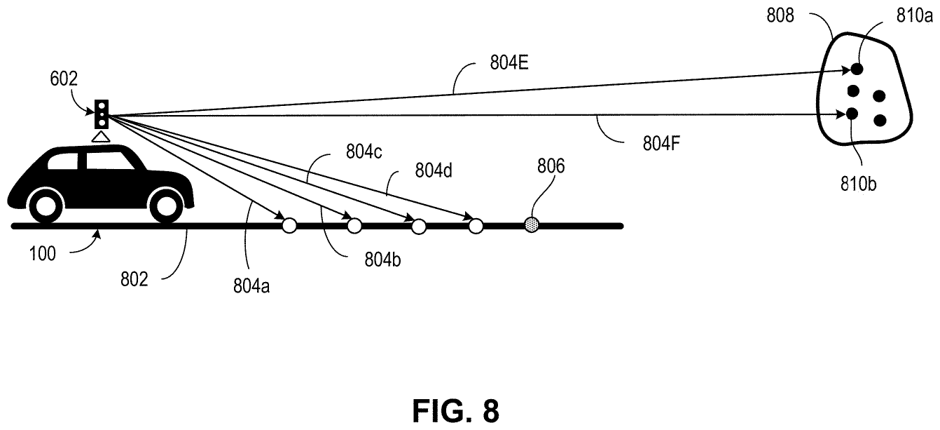

FIG. 8 is a block diagram illustrating the operation of the LiDAR system 602 in additional detail, in accordance with one or more embodiments. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

Path Planning

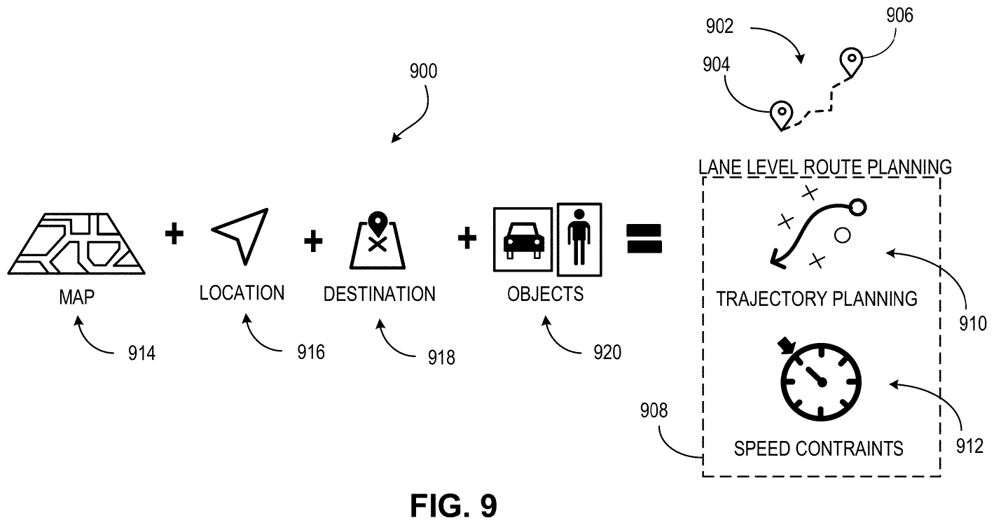

FIG. 9 is a block diagram 900 illustrating of the relationships between inputs and outputs of a planning module 404 (e.g., as shown in FIG. 4), in accordance with one or more embodiments. In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In an embodiment, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

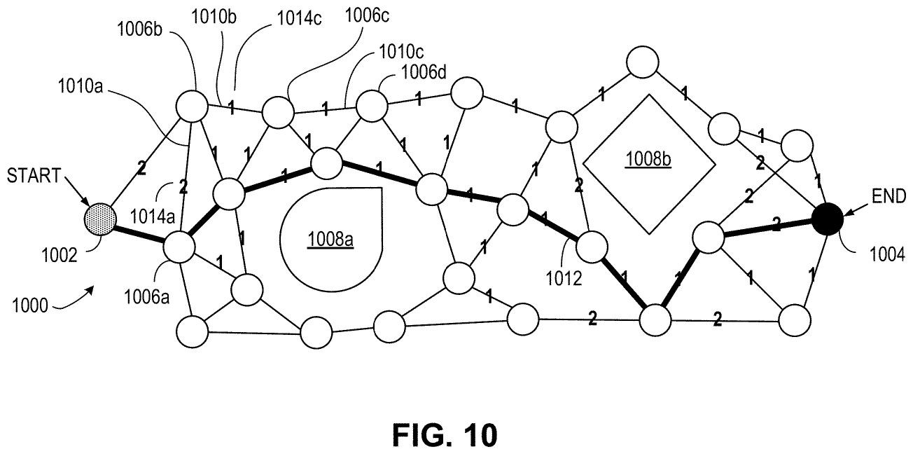

FIG. 10 illustrates a directed graph 1000 used in path planning, e.g., by the planning module 404 (FIG. 4), in accordance with one or more embodiments. In general, a directed graph 1000 like the one shown in FIG. 10 is used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, some or all of the objects 1008a-b are static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 travels between the two physical positions represented by the respective nodes.) The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

Autonomous Vehicle Control

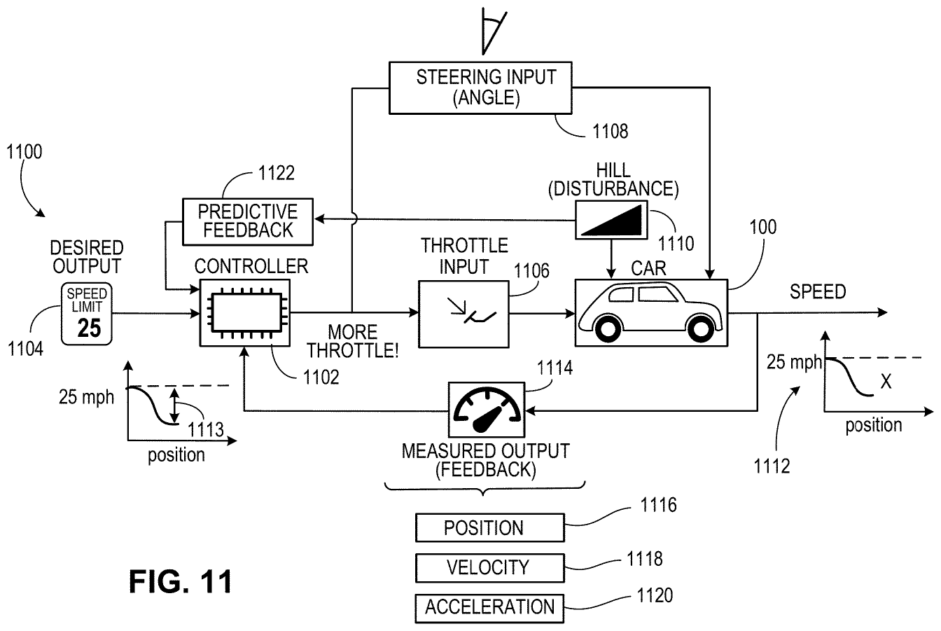

FIG. 11 is a block diagram 1100 illustrating the inputs and outputs of a control module 406 (e.g., as shown in FIG. 4), in accordance with one or more embodiments. A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 1308, and storage device 210, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

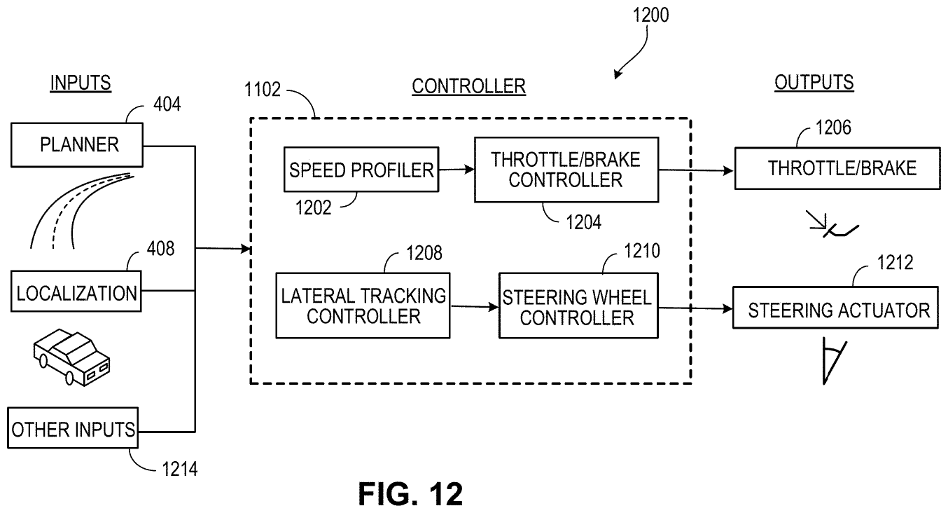

FIG. 12 is a block diagram 1200 illustrating the inputs, outputs, and components of the controller 1102, in accordance with one or more embodiments. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1204 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

Vehicle Operation Using Behavioral Rule Checks

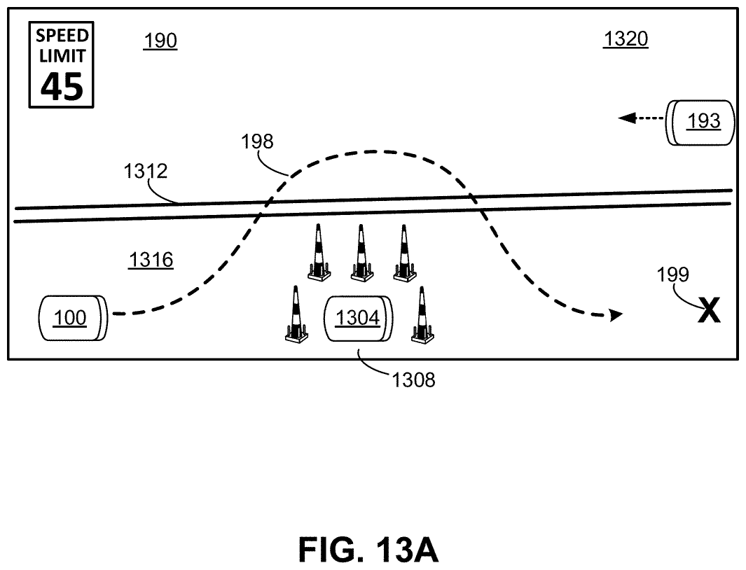

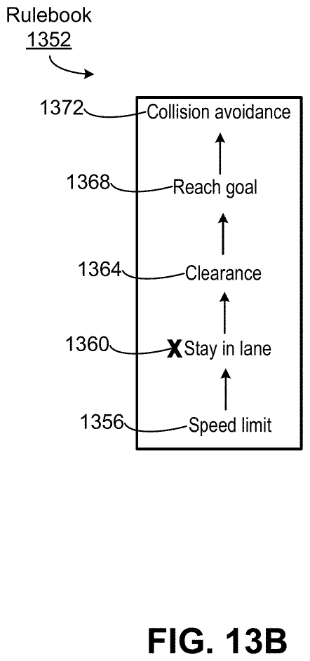

FIG. 13A illustrates an example scenario for AV 100 operation using behavioral rule checks, in accordance with one or more embodiments. The AV 100 is illustrated and described in more detail with reference to FIG. 1. The AV 100 operates in an environment 190, which is illustrated and described in more detail with reference to FIG. 1. In the example scenario illustrated in FIG. 13A, the AV 100 is operating in lane 1316 that is a one-way lane. The environment 190 includes another lane 1320 adjacent to and in an opposite direction of traffic to lane 1316. Another vehicle 193 is operating in lane 1320. The vehicle 193 is illustrated and described in more detail with reference to FIG. 1. There is a double line 1312 separating lane 1316 from lane 1320. However, there is no physical road divider or median separating lane 1316 from lane 1320. The traffic rules in the environment 190 prohibit a vehicle from crossing the double line 1312 or exceeding the speed limit of 45 miles per hour to prevent collisions.

There is a roadblock 1308 because of an incident in the lane 1316 ahead of the AV 100 in the path of the AV 100. A vehicle 1304 has either broken down or suffered a collision in the lane 1316 because of which there is the roadblock 1308. The AV 100 is operating in the lane 1316 towards the destination 199 (also in lane 1316). The destination 199 is illustrated and described in more detail with reference to FIG. 1. The roadblock 1308 and vehicle 1304 are examples of the classified objects 416, illustrated and described in more detail with reference to FIG. 4. The AV 100 uses its perception module 402 to identify the physical objects 1308, 1304 using one or more sensors 121, e.g., as also shown in FIG. 1. The perception module 402 is illustrated and described in more detail with reference to FIG. 4. The objects 1304, 1308 are classified (e.g., grouped into types such as automobile, roadblock, traffic cones, etc.) and a scenario description including the classified objects 1304, 1308 is provided to the planning module (or “planning circuit”) 404. The planning circuit 404 is illustrated and described in more detail with reference to FIG. 1.

The AV 100 determines that the lane 1316 is blocked by the objects 1304, 1308. As illustrated and described in more detail with reference to FIG. 8, the AV 100 detects the boundaries of the objects 1304, 1308 based on characteristics of data points (first sensor data) detected by the sensors 121. As shown in FIG. 8, a flat object, such as the lane 1316, will reflect light 804a-d emitted from a LiDAR system 602 in a consistent manner. The LiDAR system 602 is illustrated and described in more detail with reference to FIG. 6. Put another way, because the LiDAR system 602 emits light using consistent spacing, the lane 1316 will reflect light back to the LiDAR system 602 with the same consistent spacing. As the AV 100 travels over the lane 1316, the LiDAR system 602 will continue to detect light reflected by the next valid ground point if nothing is obstructing the lane 1316. However, if the objects 1304, 1308 obstruct the lane 1316, light 804e-f emitted by the LiDAR system 602 will be reflected from points 810a-b in a manner inconsistent with the expected consistent manner. From this information, the AV 100 can determine that the objects 1304, 1308 are present.

To reach the destination 199, the planning circuit 404 of the AV 100 generates the trajectory 198. The trajectory 198 is illustrated and described in more detail with reference to FIG. 1. Operating the AV 100 in accordance with the trajectory 198 causes the AV 100 to violate a traffic rule and cross the double line 1312 to maneuver around the objects 1304, 1308, such that the AV 100 can reach its destination 199. The trajectory 198 causes the AV 100 to cross the double line 1312 and enter lane 1320 in the path of the vehicle 193. The AV 100 uses a hierarchical set of rules of operation to provide feedback on the AV 100's driving performance. The hierarchical set of rules is sometimes referred to as a stored behavioral model or a rulebook. In some embodiments, the feedback is provided in a pass-fail manner. The embodiments disclosed herein are designed to detect when the AV 100 (e.g., the planning circuit 404) generates a trajectory 198 that violates a higher-priority behavioral rule, even though the AV 100 could have generated an alternative trajectory that would have violated only a lower-priority behavioral rule. The occurrence of such a detection denotes a failure of the motion planning process. An example hierarchical set of rules 1352 is illustrated and described in more detail with reference to FIG. 13B.

At least one processor is used to generate the trajectory 198. In a first embodiment, the at least one processor is located within the planning circuit 404 of the AV 100. For example, the at least one processor is the processor 146, illustrated and described in more detail with reference to FIG. 1. Thus, the at least one processor (processor 146 on AV 100) receives the first sensor data and the second sensor data during the operation of the AV 100. In the first embodiment, the rule-based control approach is executed on the AV 100 for real-time evaluation as a trajectory checker or as a rule-based planner/controller. For example, in the online framework, the AV uses a hierarchical set of rules of operation to provide feedback on the AV 100's driving performance iteratively during operation of the AV (e.g., when the AV crosses the double line). In particular, the online framework activates and deactivates rules depending on local sensing of relevant traffic participants or features (e.g., parked cars, pedestrians, road dividers).

In a second embodiment, the at least one processor is located on a computer device external to the AV 100. For example, the computer device is the server 136, illustrated and described in more detail with reference to FIG. 1. In the second embodiment, the at least one processor (of server 136) receives the first sensor data and the second sensor data after the operation of the AV 100. Because rulebooks are scenario-agnostic and technology-agnostic, the same rulebook can be used for different scenarios and stack builds to modify and improve the planning circuit 404 after-the-fact. In examples, the offline framework is configured to develop transparent and reproducible rule-based pass/fail evaluation of AV trajectories in test scenarios. For example, in an offline framework, a given trajectory output by the planning circuit 404 is rejected if a trajectory that leads to less violation of the rule priority structure is found. The planning circuit is modified and improved based on, at least in part, the rejected trajectory and data associated with the rejected trajectory.

The trajectory 198 is generated based on first sensor data from a first set of sensors (e.g., sensors 121) of the AV 100 and second sensor data from a second set of sensors (e.g., sensors 122) of the AV 100. In embodiments, the first sensor data represents operation of the AV 100 and the second sensor data represents the objects 1304, 1308 located in the environment 190. In the example of FIG. 1, the first set of sensors 121 includes at least one of an accelerometer, a steering wheel angle sensor, a wheel sensor, or a brake sensor. The first sensor data includes at least one of a speed of the AV 100, an acceleration of the AV 100, a heading of the AV 100, an angular velocity of the AV 100, or a torque of the AV 100. In an embodiment, the second set of sensors includes at least one of a LiDAR, a RADAR, a camera, or a microphone, an infrared sensor, a sound navigation and ranging (SONAR) sensor, and the like. In the example of FIG. 1, the second sensor data includes at least one of an image of an object (e.g., vehicle 193), a speed of the vehicle 193, an acceleration of the vehicle 193, or a lateral distance between the vehicle 193 and the AV 100. Specific sensors of the first set of sensors and the second set of sensors are described for ease of description. However, the present techniques can be implemented using sensors that characterize information associated with the AV, information associated with the objects, information associated with the environment, or any combinations thereof. Generally, the first set of sensors are dynamic sensors that capture dynamic data. For example, dynamic data includes centrifugal forces, gravitational forces, velocity, and the like. Generally, the second set of sensors are kinematic sensors that capture kinematic data. In examples, kinematic data describes motion of an object relative to the AV. For example, kinematic data includes at least one of an image of the at least one object, a speed of the at least one object, an acceleration of the at least one object, a lateral distance between the at least one object and the vehicle, a longitudinal distance between the at least one object and the vehicle, the jerk of an object, and the like. In examples, the data captured by the first set of sensors or the second set of sensors is a time derivative, or expressed as the rate of change of the value of a function.

In an embodiment, the processor 146 continuously or periodically receives the first sensor data from the first set of sensors 121 of the AV 100 and the second sensor data from the second set of sensors 122 of the AV 100. The first sensor data and second sensor data thus represent the particular scenario (FIG. 13A) the AV 100 is operating in. In an example, the particular scenario is used to determine the rules activated in an online framework. In an embodiment, the processor 146 determines that the trajectory 198 violates a first behavioral rule of the hierarchical set of rules of operation of the AV 100. The processor 146 determines that the trajectory 198 violates the first behavioral rule (crossing the double line 1312 when there is traffic—vehicle 193—in lane 1320) based on the first sensor data and the second sensor data. For example, the first behavioral rule denotes that the AV 100 should not cross the double line 1312 in the presence of traffic to prevent collisions. (Alternatively if the trajectory 198 in use does not violate any behavioral rules, the planning circuit 404 and AV system 120 pass the behavioral verification process.)

Violations of the hierarchical set of rules of operation of the AV 100 are determined with respect to one or more objects (e.g., objects 1304, 1308 and vehicle 193) located in the environment 190. For example, criteria are defined for flagging a trajectory 198 as potentially failing. A simple criterion is violation of a single behavioral rule, and other formulations are also possible. For example, given a trajectory 198 (e.g., a potential trajectory, an actual trajectory, or another trajectory) generated by the planning circuit 404 of the AV 100, the embodiments described herein provide feedback on the trajectory 198 in terms of the priority of rules violated. In examples, the online framework updates the trajectory iteratively as the AV proceeds through an environment 190. In this example, the given trajectory is a portion or subset of a larger trajectory.

In an embodiment, the processor determines a path of a moving object (e.g., vehicle 193) based on the second sensor data. For example, as the vehicle 193 moves, the processor determines a geometric path formed by successive positions of an end of a position vector of the vehicle 193 over time. The processor can denote the coordinates x, y and z of the position vector written as a function of time, for example, x(t),y(t) and z(t) to represent the evolution of the position of the vehicle 193 with time, that is, the path of the vehicle 193. The processor determines that the first trajectory 198 violates the first behavioral rule based on the path of the vehicle 193. For example if points on the trajectory 198 are less than a threshold distance away from points on the path, the first behavioral rule may be violated.

The first behavioral rule, that is, the rule violated by trajectory 198 has a first priority. In an embodiment, each behavioral rule of the hierarchical set of rules has a respective priority with respect to each other behavioral rule of the hierarchical set of rules. The respective priority represents a risk level of violating the each behavioral rule with respect to the each other behavioral rule. The at least one processor generates multiple alternative trajectories for the AV 100 based on the first sensor data and the second sensor data. For example, the multiple alternative trajectories can be based on a position of the AV 100, a speed of the AV 100, a position of the vehicle 193, or a speed of the vehicle 193. Each alternative trajectory represents choices the AV 100 could have made instead of generating the trajectory 198. The multiple alternative trajectories are generated either in real-time by processor 146 during operation of the AV 100 (as in the first embodiment described above) or after-the-fact on server 136 (as in the second embodiment described above).

In an embodiment, the multiple alternative trajectories are generated using control barrier functions (CBFs). A barrier function is a continuous function whose value on a point increases to infinity as the point approaches the boundary of the feasible region of the optimization problem. Such functions can be used to replace inequality constraints by a penalizing term in the objective function that is easier to handle. A CBF takes as input the current system state (e.g., data associated with a position of the AV 100, a speed of the AV 100, an acceleration of the AV 100, or a distance of the AV 100 from the objects 1304, 1308) and outputs a real number corresponding to the safety state of the system. As the system approaches an unsafe operating point, the CBF value increases to infinity. CBFs can be composed with control Lyapunov functions (CLFs) to provide joint guarantees on stability, performance, and safety. A Lyapunov function V(x) refers to a scalar function that can be used to determine the stability of an equilibrium of an ordinary differential equation. A CLF refers to a Lyapunov function V(x) for a system (e.g., the AV system 120 or the planning circuit 404) having control inputs. A regular Lyapunov function can be used to test whether a dynamical system is stable, that is, whether the system starting in a state x≠0 in some domain D will remain in D, or for asymptotic stability will eventually return to x=0. The CLF is used to test whether a system is feedback stabilizable, that is, whether for a state x there exists a control u(x, t), such that the system can be brought to the zero state by applying the control u. For example, the offline framework achieves trajectory tracking through additional constraints implemented using CLFs. In an online framework, a reference trajectory is tracked by including a tracking error in the cost and by performing optimization over a receding horizon (MPC).

The at least one processor identifies a second trajectory from the multiple alternative trajectories. For example, in accordance with the second trajectory, the AV 100 comes to a stop in lane 1316 and then crosses the double line 1312 after the vehicle 193 has passed. The second trajectory thus violates only a second behavioral rule (crossing the double line 1312 when there is no traffic in lane 1320) of the hierarchical set of rules. The second behavioral rule has a second priority less than the first priority. Preventing a collision—crossing the double line 1312 when there is traffic in lane 1320—has a greater priority than simply crossing the double line 1312 when there is no traffic in lane 1320. Alternatively if the second trajectory violates a higher-priority rule, the planning circuit 404 and AV system 120 pass the behavioral verification because no alternative trajectory having a smaller degree of rule violations could be found.

In the first embodiment described above, responsive to identifying the second trajectory, the at least one processor 146 transmits a message to a control circuit 406 of the AV 100 to operate the AV 100 based on the second trajectory. The control circuit 406 is illustrated and described in more detail with reference to FIG. 4. For example, if the at least one processor 146 belongs to the planning circuit 404, the AV 100 is operated in real-time based on the second trajectory. If the at least one processor is on the off-line server 136, the second trajectory is used to reprogram the planning circuit 404, as in the second embodiment described above. In an embodiment, the results of the feedback from trajectory verification are “PASS,” e.g., the trajectory 198 is either satisfactory, or an alternative trajectory is not available, or “FAIL,” e.g., the AV trajectory 198 does not conform to rulebook behavioral specifications and there is an alternative trajectory available that either violates no behavioral rule or violates a lower-priority behavioral rule than does the trajectory 198. The trajectory 198 is deemed “FAIL” if such an alternative trajectory is identified.

The embodiments disclosed herein are designed to prevent “trivially satisfying” trajectories, e.g., trajectories where the AV 100 comes to a stop or does not reach its goal 199, from being deemed an alternative solution to a trajectory that reaches the goal with rule violations. A rule to “reach goal” is explicitly built into rulebooks. The processor 146 operates the AV 100 based on the trajectory 198 to avoid a collision of the AV 100 and objects 1304, 1308 and the vehicle 193. For example, the control module 406, illustrated and described in more detail with reference to FIG. 4, operates the AV 100.

FIG. 13B illustrates an example hierarchical set of rules 1352, in accordance with one or more embodiments. The stored behavioral rules of the operation of the AV 100 includes multiple behavioral rules. The AV 100 is illustrated and described in more detail with reference to FIGS. 1, 13A. Each behavioral rule (e.g., rule 1356) has a priority with respect to each other rule (e.g., rule 1360). The priority represents a risk level of a violation of the stored behavioral rules 1352. The rulebook 1352 is therefore a formal framework to specify driving requirements enforced by traffic laws or cultural expectations as well as their relative priorities. The rulebook 1352 is a pre-ordered set of rules having violation scores that capture the hierarchy of the rule priorities. Hence, the rulebook 1352 enables AV behavior specification and assessment in conflicting scenarios. Consider the case where a pedestrian 192 walks in to the lane in which the AV 100 is driving. The pedestrian 192 is illustrated and described in more detail with reference to FIG. 1. A reasonable AV behavior would be to avoid collision with the pedestrian 192 and other vehicles 193 (high priority), although at the cost of violating lower priority rules by reducing speed to less than a minimum speed limit or by deviating from a lane.

In an embodiment, violating a behavioral rule includes operating the AV 100 such that the AV 100 collides with the vehicle 193. The vehicle 193 is illustrated and described in more detail with reference to FIGS. 1, 13A. For example, a risk of a collision between the AV 100 and the vehicle 193 is greater if rule 1360 is violated than if only rule 1356 is violated. Therefore, rule 1360 has a higher priority than rule 1356. Similarly, rule 1372 has a higher priority than rules 1368, 1364.

In an embodiment, violating a behavioral rule includes operating the AV 100 such that the AV 100 exceeds a speed limit (e.g., 45 mph). For example, the rule 1356 denotes that the AV 100 should not violate the speed limit of the lane it is traveling in. For example, in FIG. 13A the speed limit for lane 1316 is 45 miles per hour. However, rule 1356 is a lower priority rule; hence, the AV 100 may violate rule 1356 in order to prevent a collision (e.g., with the vehicle 193) and act in accordance with rule 1372. In an embodiment, violating a behavioral rule includes operating the AV 100 such that the AV 100 stops before reaching a destination 199. The destination 199 is illustrated and described in more detail with reference to FIGS. 1, 13A. For example, the rule 1360 denotes that the AV 100 should stay in its own lane. For example, in FIG. 13A the AV 100 is traveling in lane 1316. However, the priority of rule 1360 is lower than the priority of rule 1372. Hence, as illustrated and described in more detail with reference to FIG. 13A, the AV 100 violates only rule 1360 to avoid colliding with the objects 1304, 1308 and to obey the two higher-priority rules 1368 (reach the destination 199) and 1372 (avoid collision).

In an embodiment, a violation of the stored behavioral rules 1352 of operation of the AV 100 includes operating the AV 100 such that a lateral clearance between the AV 100 and the objects 1304, 1308 decreases below a threshold lateral distance. For example, the rule 1364 denotes that the AV 100 should maintain a threshold lateral distance (e.g., one half car length or 1 meter) from any other object (e.g., objects 1304, 1308). However, the priority of rule 1364 is lower than the priority of rule 1368 (reach destination 199). Hence, as illustrated and described in more detail with reference to FIG. 13A, the AV 100 may violate rule 1364 to obey the higher-priority rules 1368 (reach the destination 199) and 1372 (avoid collisions).

In an embodiment, surrogate safety metrics are used to assess AV safety. The surrogate safety metrics are used to more rapidly evaluate road safety and integrate the concept into a holistic theoretical framework. The priority of a rule of operation (e.g., rule 1356) can be adjusted based on a frequency of the violation. For example, empirical evidence from human driver data can be used in support of the application of the stored behavioral rules 1352 of FIG. 13B to road safety.

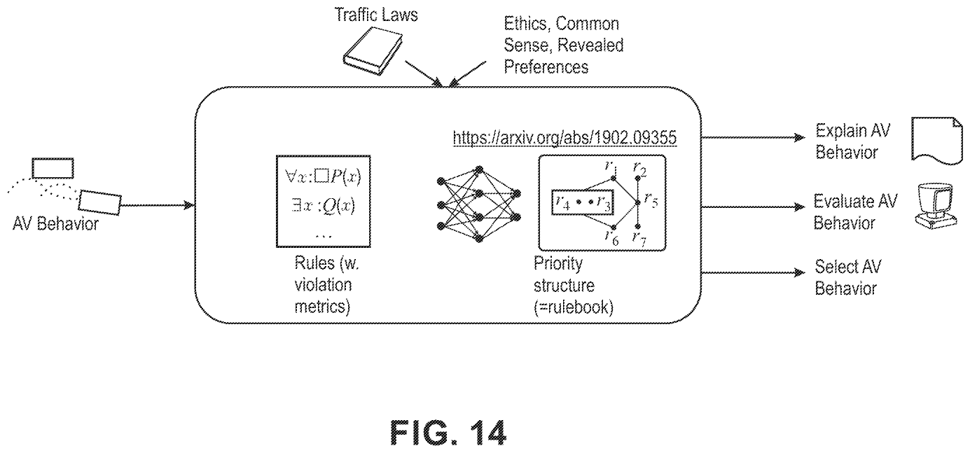

FIG. 14 illustrates an example flow diagram for AV 100 operation using behavioral rule checks, in accordance with one or more embodiments. In the first embodiment (described with reference to FIG. 13A), the process of FIG. 14 is performed by processor 146 of the AV 100, described in more detail with reference to FIG. 1. That is, the at least one processor 146 is located within the planning circuit 404 of the AV 100. The at least one processor 146 receives the first sensor data and the second sensor data (AV behavior) during the operation of the AV 100. Thus, the rule-based control approach (select AV behavior) described herein is executed on the AV 100 for real-time evaluation as a trajectory checker or as a rule-based planning circuit 404 or controller. Likewise, embodiments may include different and/or additional steps, or perform the steps in different orders. The planning circuit 404 is illustrated and described in more detail with reference to FIG. 4.

In the second embodiment (described with reference to FIG. 13A), the at least one processor (on server 136) adjusts operation of the planning circuit 404 of the AV 100 based on the second trajectory (described with reference to FIG. 13A). In the second embodiment, the at least one processor is located on a computer device (server 136) external to the AV 100. The server 136 receives the first sensor data (AV behavior) and the second sensor data after the operation of the AV 100. For example, as illustrated in FIG. 14, the motion planning process of the planning circuit 404 is adjusted based on a frequency of violations of the behavioral rules. For example, a validated rulebook 1352 (illustrated and described in more detail with reference to FIG. 13B) is applied to design and implement automated vehicle systems 120. In the case of machine drivers, which usually have system models, the driving performance can evaluate AV driving performance (evaluate AV behavior) using rulebooks.

In an embodiment, a risk level of the motion planning process of the AV 100 is determined based on the frequency of the one or more violations of the stored behavioral rules 1352 (explain AV behavior). The rules 1352 are illustrated and described in more detail with reference to FIG. 13B. For example, the effects of design of the AV system 120 and performance of the planning circuit 404 on planned trajectories are modeled as shown in FIG. 14. The AV system 120 is illustrated and described in more detail with reference to FIG. 1. The planning circuit 404 is illustrated and described in more detail with reference to FIG. 4. Planned trajectories are scored to measure overall driving performance as a function of the AV system 120's design and subsystem (planning circuit 404) performance. (Sub)system requirements are derived from behavior specification (rules 1352), optimize performance, and prioritize resources.

In an embodiment, the at least one processor selects the second trajectory from the multiple alternative trajectories using at least one of minimum-violation planning, model predictive control (MPC), or machine learning. Minimum violation planning refers to a method for path planning for the AV 100 that enables using multiple continuous objectives (e.g., finding the shortest path) with discrete constraints that come from logic, such as the constraints arising from the hierarchical set of rules 1352. MPC refers to a method used to control a process (trajectory generation and selection) while satisfying a set of constraints (hierarchical set of rules 1352). In an embodiment, MPC uses a dynamic model of the AV system 120 that is a linear empirical model. The AV system 120 is illustrated and described in more detail with reference to FIG. 1. Machine learning refers to generating an alternative trajectory using a model that improves automatically through experience. The AV system 120 or server 136 builds a mathematical model based on sample data, known as “training data”, in order to make predictions or decisions without being explicitly programmed to do so. For example, the training data for selecting the second trajectory is the hierarchical set of rules 1352 and known outcomes of violating particular rules. Thus, as illustrated in FIG. 14, in the second embodiment described with reference to FIG. 13A, candidate trajectories are selected from multiple approaches after-the-fact with the benefit of information about the scenario and how the AV 100 behaved.

For example, the online framework implements a receding horizon (Model Predictive Control, MPC) optimization, in which the reference trajectory tracking error is included in a cost. In the online framework, the active rules (e.g., rules that correspond to detected instances or a particular scenario) at a given time add constraints to the optimization problem in the online case. The rules are classified into instance-dependent (such as clearance with pedestrian, clearance with parked) and instance-independent rules (such as speed limit and comfort). Instance-independent rules should always be taken into account. However, instance-dependent rules should only be considered when the corresponding instances are within the AV's local sensing range. A local sensing range generally refers to the extent of sensor data available to the AV, such as data is captured by sensors located on the AV or associated with the AV.

In embodiments, upon initialization or at time t=0, instance-dependent rules are deactivated in the hierarchical set of rules. As instances occur, corresponding instance-dependent rules are activated. For each instance at a current time t, deactivated rules (e.g., rules not applicable to the current instances) are removed from the hierarchical set of rules. Thus in an online approach the hierarchical set of rules is iteratively modified as instances occur. In examples, the modification occurs periodically according to a predetermined time period. In examples, the activated rules are activated as long as the corresponding instance occurs.

Referring again to FIG. 13B, a set of hierarchical set of rules 1352 is provided. Consider an example with a roadblock and objects (e.g., 1304, 1308, FIG. 13A) blocking the lane of travel of the AV as described with respect to FIG. 13A. In this example, an instance is a roadblock in the lane of travel. As illustrated in the example of FIG. 13A, no pedestrians are within the local sensing range of the AV. In this example, rules associated with pedestrians (e.g., no instance detected) are deactivated. The rules associated with the instance of pedestrians being detected are deleted from the hierarchical set of rules as the AV navigates around the roadblock.

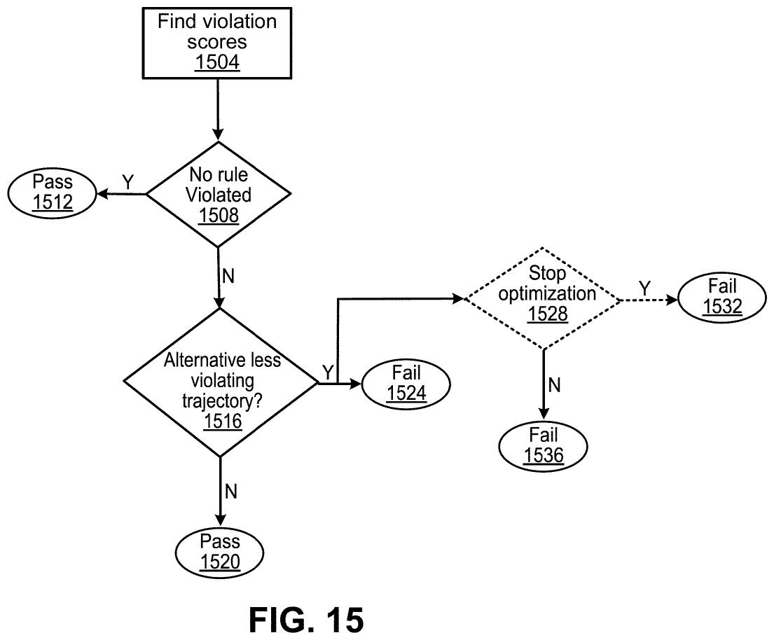

FIG. 15 illustrates an example flow diagram for vehicle operation using behavioral rule checks, in accordance with one or more embodiments. In the first embodiment (described with reference to FIG. 13A), the process of FIG. 15 is performed by processor 146 of the AV 100, described in more detail with reference to FIG. 1. In the second embodiment (described with reference to FIG. 13A), at least one processor (on server 136) performs the process of FIG. 15. Likewise, embodiments may include different and/or additional steps, or perform the steps in different orders.

In step 1504, a processor determines whether a first trajectory (e.g., trajectory 198) violates any behavioral rule of a hierarchical set of rules 1352 of operation of the AV 100 based on the first sensor data and the second sensor data. The trajectory 198 is illustrated and described in more detail with reference to FIGS. 1, 13A. The hierarchical set of rules 1352 is illustrated and described in more detail with reference to FIG. 13B. In step 1508, if the processor finds no rules are violated, the process moves to step 1512 and the planning circuit 404 and AV behavior pass the verification checks. The planning circuit 404 is illustrated and described in more detail with reference to FIG. 4.

In step 1508, if the processor finds a rule is violated, the process moves to step 1516. The violated rule is denoted as a first behavioral rule having a first priority. In step 1516, the processor determines whether an alternative less-violating trajectory exists. For example, the processor generates multiple alternative trajectories for the AV 100 based on the first sensor data and the second sensor data. The multiple alternative trajectories can be generated using CBFs as described in more detail with reference to FIG. 13A. The processor identifies whether there exists a second trajectory that violates only a second behavioral rule of the hierarchical set of rules 1352, such that the second behavioral rule has a second priority less than the first priority.

If no other trajectory exists that violates only a second behavioral rule having a lower priority than the first priority, the process moves to step 1520. The planning circuit 404 and AV behavior pass the verification checks. In step 1516, if the processor determines that an alternative less-violating trajectory exists, the planning circuit 404 and AV behavior fail the verification checks. Optionally, the processor can move to step 1528 and determine whether to stop optimization (move further to step 1532 and terminate) or move to step 1536. In step 1536, the processor examines each alternative trajectory of the multiple alternative trajectories to identify a least-violating trajectory, e.g., an alternative trajectory that either violates no rule or violates a rule having the lowest priority of any violated rule. The least-violating trajectory can be used to operate the AV 100 (in the first embodiment described with reference to FIG. 13A) or adjust the planning circuit 404 (in the second embodiment described with reference to FIG. 13A).

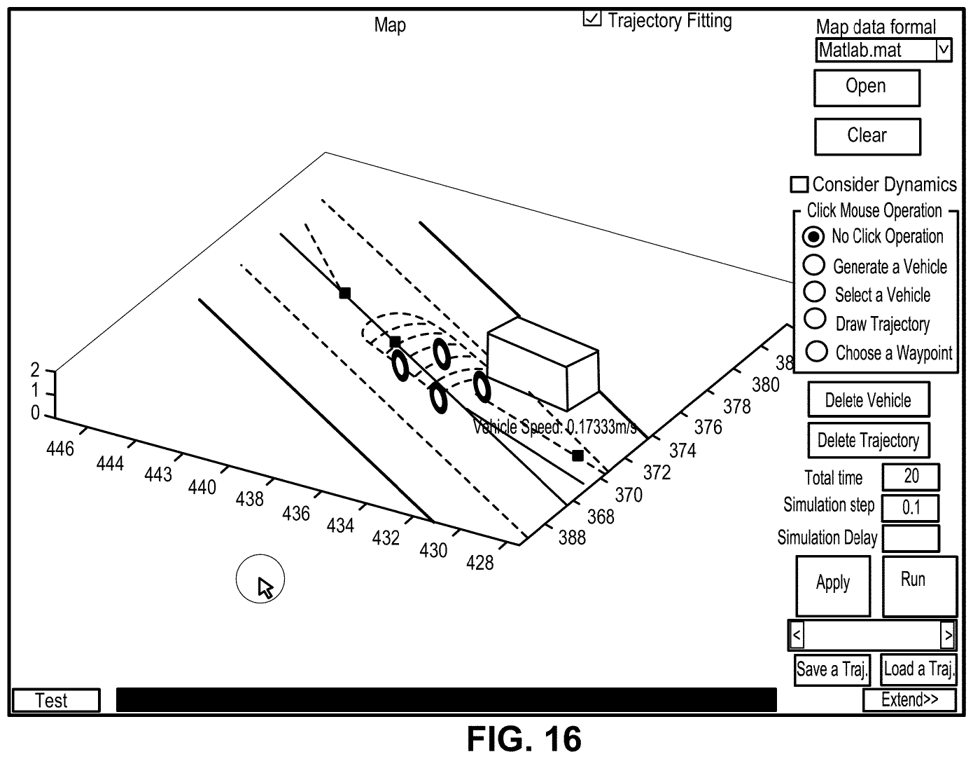

FIG. 16 illustrates an example of performing behavioral rule checks for the AV 100, in accordance with one or more embodiments. The AV 100 is illustrated and described in more detail with reference to FIGS. 1, 13A. In FIG. 16, the graphical user interface is displayed on the server 136, where multiple alternative trajectories are generated. The different trajectories are examined to identify a least-violating trajectory based on the first sensor data and the second sensor data. The data generated on the graphical user interface when performing behavioral rule checks for the AV 100 as shown in FIG. 16 are used to adjust and improve trajectory generation by the planning circuit 404 in the second embodiment, described with reference to FIG. 13A. The planning circuit 404 is illustrated and described in more detail with reference to FIG. 4.

FIG. 16 displays an implementation of control strategies for AVs to meet complex specifications (e.g., rulebook 1352) designed from traffic laws and cultural expectations of a reasonable driving behavior. These specifications are specified as rules (see FIG. 13B) and priorities by constructing a pre-order structure called a rulebook 1352. The embodiments disclosed present a recursive framework in which the satisfaction of the rules in the rulebook 1352 are iteratively relaxed based on their priorities. In an embodiment, convergence to desired states is achieved—using (CLFs) and safety is enforced through CBFs. CLFs can be used to stabilize systems to desired states. CBFs can be used to enforce set forward-invariance and improve the satisfaction of safety requirements. The framework can be used for after-the-fact, pass/fail evaluation of trajectories—a given trajectory 198 is rejected if the process finds a controller producing an alternative trajectory that leads to less violation of the rulebook 1352.

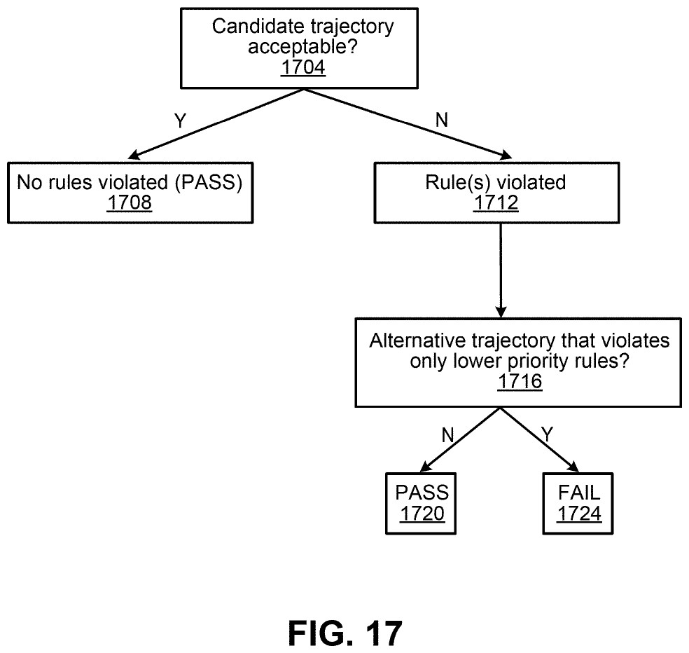

FIG. 17 illustrates an example flow diagram for vehicle operation using behavioral rule checks, in accordance with one or more embodiments. In the first embodiment (described with reference to FIG. 13A), the process of FIG. 17 is performed by processor 146 of the AV 100, described in more detail with reference to FIG. 1. In the second embodiment (described with reference to FIG. 13A), at least one processor (on server 136) performs the process of FIG. 17. Likewise, embodiments may include different and/or additional steps, or perform the steps in different orders.

In step 1704, a processor determines whether a trajectory (e.g., the trajectory 198) for the AV 100 is acceptable. The trajectory 198 and AV 100 are illustrated and described in more detail with reference to FIGS. 1, 13A. For example, in step 1704, the processor determines whether the trajectory 198 violates any behavioral rule of a hierarchical set of rules 1352 of operation of the AV 100 based on the first sensor data and the second sensor data. The hierarchical set of rules 1352 is illustrated and described in more detail with reference to FIG. 13B. In step 1704, if the processor finds no rules are violated, the process moves to step 1708 and the planning circuit 404 and AV behavior pass the verification checks. The planning circuit 404 is illustrated and described in more detail with reference to FIG. 4.

In step 1704, if the processor finds a rule is violated, the process moves to step 1712. The violated rule is denoted as a first behavioral rule having a first priority. The process moves to step 1716. In step 1716, the processor determines whether an alternative less-violating trajectory exists. For example, the processor generates multiple alternative trajectories for the AV 100 based on the first sensor data and the second sensor data. The multiple alternative trajectories can be generated using control barrier functions as described in more detail with reference to FIG. 13A. The processor identifies whether there exists a second trajectory that violates only a second behavioral rule of the hierarchical set of rules 1352, such that the second behavioral rule has a second priority less than the first priority.

If no other trajectory exists that violates only a second behavioral rule having a lower priority than the first priority, the process moves to step 1720. The planning circuit 404 and AV behavior pass the verification checks. In step 1716, if the processor determines that an alternative less-violating trajectory exists, the planning circuit 404 and AV behavior fail the verification checks.

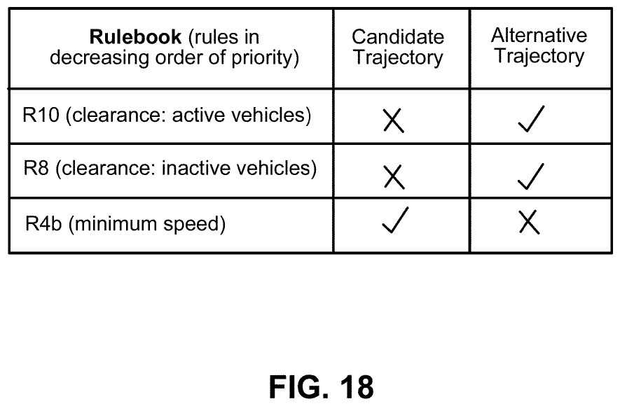

FIG. 18 illustrates an example output of performing behavioral rule checks for a vehicle, in accordance with one or more embodiments. In the first embodiment (described with reference to FIG. 13A), the example output of FIG. 18 is used by processor 146 of the AV 100, described in more detail with reference to FIG. 1. In the second embodiment (described with reference to FIG. 13A), at least one processor (on server 136) uses the output of FIG. 18. The example output denotes that a candidate trajectory (e.g., trajectory 198) under verification violates rule R10 (minimum lateral clearance from other active vehicles on the road). For example, the trajectory 198 causes the AV 100 to operate closer to an active vehicle (e.g., vehicle 193) than a minimum threshold distance. The vehicle 193 is illustrated and described in more detail with reference to FIGS. 1, 13A. The example output denotes that a second (alternative) trajectory obeys rule R10.

The example output denotes that the candidate trajectory 198 violates rule R8 (minimum lateral clearance from other inactive vehicles on the road). For example, the trajectory 198 causes the AV 100 to operate closer to an inactive vehicle (e.g., vehicle 1304) than a minimum threshold distance. The vehicle 1304 is illustrated and described in more detail with reference to FIG. 13A. The example output denotes that the alternative trajectory obeys rule R8. Rule R10 has a higher priority than rule R8, which means the AV 100 should strive to meet rule R10 even if it must violate rule R8 to do so.

The example output denotes that the candidate trajectory 198 obeys rule R4b (minimum speed limit on the road). For example, the trajectory 198 causes the AV 100 to drive slower than a minimum speed limit. The example output denotes that the alternative trajectory violates rule R4b. Rules R8, R10 have a higher priority than rule R4b, which means the AV 100 should strive to meet rules R8, R10 even if it must violate rule R4b to do so. However, the trajectory 198 causes the AV 100 to obey rule R4b while violating Rules R8, R10. The alternative trajectory causes the AV 100 to violate rule R4b while obeying Rules R8, R10. Hence, the trajectory check on trajectory 198 fails and the alternative trajectory is used.

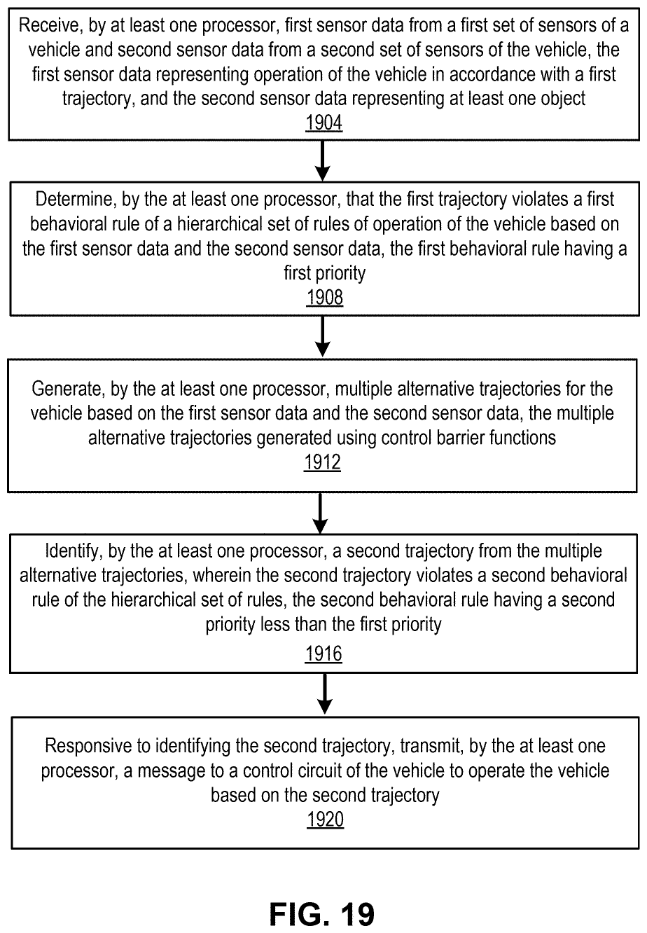

FIG. 19 illustrates an example flow diagram for vehicle operation using behavioral rule checks, in accordance with one or more embodiments. In the first embodiment (described with reference to FIG. 13A), the process of FIG. 19 is performed by processor 146 of the AV 100, described in more detail with reference to FIG. 1. In the second embodiment (described with reference to FIG. 13A), at least one processor (on server 136) performs the process of FIG. 19. Likewise, embodiments may include different and/or additional steps, or perform the steps in different orders.

In step 1904, a processor receives first sensor data from a first set of sensors 120 of the AV 100 and second sensor data from a second set of sensors 121 of the AV 100. The sensors 120, 121 are illustrated and described in more detail with reference to FIG. 1. The first sensor data represents operation of the AV 100 in accordance with a first trajectory 198. The trajectory 198 is illustrated and described in more detail with reference to FIGS. 1, 13A. The second sensor data represents at least one object 1304, 1308. The objects 1304, 1308 are illustrated and described in more detail with reference to FIG. 13A.

In step 1908, the processor determines that the first trajectory 198 violates a first behavioral rule (e.g., rule 1360) of a hierarchical set of rules 1352 of operation of the AV 100 based on the first sensor data and the second sensor data. The rule 1360 and the hierarchical set of rules 1352 are illustrated and described in more detail with reference to FIG. 13B. The first behavioral rule 1350 has a first priority.

In step 1912, the processor generates multiple alternative trajectories for the AV 100 based on the first sensor data and the second sensor data. The multiple alternative trajectories are generated using CBFs. The processor iteratively relaxes the rules it needs to satisfy to determine if a second trajectory with less violation exists. The processor uses CLFs and CBFs, which together guarantee that if a feasible, lower-violation trajectory exists, the algorithm will converge to it. The iteratively relaxing rules can be used with other trajectory generation methods, including graph-based search, combined MPC, or a machine learning based planning method.

In step 1916, the processor identifies a second trajectory from the multiple alternative trajectories. The second trajectory violates a second behavioral rule (e.g., rule 1356) of the hierarchical set of rules 1352. The rule 1356 is illustrated and described in more detail with reference to FIG. 13B. The second behavioral rule has a second priority less than the first priority. The constraints are required to be continuously differentiable, making the optimization problem a quadratic problem. A continuously differentiable function refers to a function whose derivative exists at each point in its domain. In other words, the graph of a continuously differentiable function has a non-vertical tangent line at each interior point in its domain. Rules are approximated to be not differentiable with conservative, differentiable functions that are faster to evaluate than more-complex rules. Because the optimization problem is quadratic, the computational complexity is reduced. For example, a non-linear solver, such as a Newton-Krylov solver, an Anderson solver, or a Broyden solver can be used to solve the optimization problem by modeling the AV system 120 as a non-linear system. Thus, the method is easier to implement on the AV 100's embedded software while meeting rigorous automotive safety requirements.

In step 1920, responsive to identifying the second trajectory, the processor transmits a message to a control circuit 406 of the AV 100 to operate the AV 100 based on the second trajectory. The control circuit 406 is illustrated and described in more detail with reference to FIG. 4. The embodiments disclosed herein extend beyond on-car planning and control by providing a scalable, objective way to pass or fail AV behavior in test cases after-the-fact. The after-the-fact evaluation can help justify driving choices that the AV 100 made in the real world by objectively demonstrating that no more “reasonable” choices were available to the AV 100.

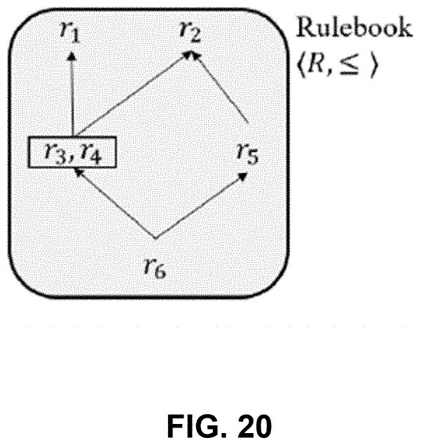

FIG. 20 illustrates an example hierarchical set of rules for AV 100 operation using behavioral rule checks, in accordance with one or more embodiments. The AV 100 is illustrated and described in more detail with reference to FIGS. 1, 13A. A behavioral rule specifies a desired behavior for the AV 100, such that the AV 100 complies with the traffic laws, ethics and local culture, e.g., “stay in lane,” “maintain clearance from pedestrians 192,” “obey the maximum speed limit,” “reach the goal 199 within a deadline.” The pedestrian 192 is illustrated and described in more detail with reference to FIG. 1.

Rules are interpreted over vehicle trajectories. Given a trajectory 198 and a rule, a violation score captures the degree of violation of the rule by the trajectory 198. The trajectory 198 is illustrated and described in more detail with reference to FIGS. 1, 13A. For example, if the AV 100 crosses the double line 1312 and reaches the lane 1320 by a distance of 1 m along the trajectory 198, then the violation score for that trajectory 198 against the “stay in lane” rule is 1 m. The double line 1312 and lane 1320 are illustrated and described in more detail with reference to FIG. 13A.

The rulebook 1352 defines priority on rules, and imposes a pre-order that can be used to rank AV trajectories. The rulebook 1352 is illustrated and described in more detail with reference to FIG. 13B. The rulebook 1352 is a tuple (R, ≤), where R denotes a finite set of rules and ≤denotes a pre-order on R. The rulebook 1352 can also be represented by a directed graph, where each node is a rule and an edge between two rules means that the first rule has higher priority than the second. Formally, r1→r2 in the graph means that r1≤r2 (r2∈R has a higher priority than r1∈R). Using a pre-order, two rules can be in one of three relations: comparable (one has a higher priority than the other), incomparable, or equivalent (each has equal priority).

The rulebook shown in FIG. 20 includes six rules. In the example, rules r1 and r2 are incomparable, and both have a higher priority than rules r3 and r4. Rules r3 and r4 are equivalent (r3≤r4 and r4≤r3), but are incomparable to rule r5. Rule r6 has the lowest priority among all rules.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

1. A method comprising:
receiving, by at least one processor, first sensor data from a first set of sensors of a vehicle and second sensor data from a second set of sensors of the vehicle, the first sensor data representing operation of the vehicle in accordance with a first trajectory, and the second sensor data representing at least one object;
determining, by the at least one processor, that the first trajectory violates a first behavioral rule of a hierarchical plurality of rules of operation of the vehicle based on the first sensor data and the second sensor data, the first behavioral rule having a first priority;
generating, by the at least one processor, a plurality of alternative trajectories for the vehicle based on the first sensor data and the second sensor data, the plurality of alternative trajectories generated using control barrier functions;
identifying, by the at least one processor, a second trajectory from the plurality of alternative trajectories, wherein the second trajectory violates a second behavioral rule of the hierarchical plurality of rules, the second behavioral rule having a second priority less than the first priority; and
responsive to identifying the second trajectory, transmitting, by the at least one processor, a message to a control circuit of the vehicle to operate the vehicle based on the second trajectory.

2. The method of claim 1, wherein the at least one processor is located within a planning circuit of the vehicle, and wherein the at least one processor receives the first sensor data and the second sensor data during the operation of the vehicle.

3. The method of claim 1, further comprising adjusting, by the at least one processor, operation of a planning circuit of the vehicle based on the second trajectory, wherein the at least one processor is located on a computer device external to the vehicle, and wherein the at least one processor receives the first sensor data and the second sensor data after the operation of the vehicle.

4. The method of claim 1, wherein the first set of sensors comprises at least one of an accelerometer, a steering wheel angle sensor, a wheel sensor, or a brake sensor.

5. The method of claim 1, wherein the first sensor data comprises at least one of a speed of the vehicle, an acceleration of the vehicle, a heading of the vehicle, an angular velocity of the vehicle, or a torque of the vehicle.

6. The method of claim 1, wherein the second set of sensors comprises at least one of a LiDAR, a RADAR, a camera, a microphone, an infrared sensor, or a sound navigation and ranging (SONAR) sensor.

7. The method of claim 1, wherein the second sensor data comprises at least one of an image of the at least one object, a speed of the at least one object, an acceleration of the at least one object, a lateral distance between the at least one object and the vehicle, or other kinematic data.

8. The method of claim 1, further comprising selecting, by the at least one processor, the second trajectory from the plurality of alternative trajectories using at least one of minimum-violation planning, model predictive control, or machine learning, the selecting based on the hierarchical plurality of rules.

9. The method of claim 1, wherein each behavioral rule of the hierarchical plurality of rules has a respective priority with respect to each other behavioral rule of the hierarchical plurality of rules, the respective priority representing a risk level of violating the each behavioral rule with respect to the each other behavioral rule.

10. The method of claim 1, wherein violating the first behavioral rule comprises operating the vehicle such that a lateral distance between the vehicle and the at least one object decreases below a threshold lateral distance.

11. The method of claim 1, wherein violating the first behavioral rule comprises operating the vehicle such that the vehicle exceeds a speed limit.

12. The method of claim 1, wherein violating the first behavioral rule comprises operating the vehicle such that the vehicle stops before reaching a destination.

13. The method of claim 1, wherein violating the first behavioral rule comprises operating the vehicle such that the vehicle collides with the at least one object.

14. The method of claim 1, further comprising determining, by the at least one processor, a path of the at least one object based on the second sensor data, wherein determining that the first trajectory violates the first behavioral rule is further based on the path of the at least one object.

15. An autonomous vehicle comprising:
one or more processors; and
one or more non-transitory storage media storing instructions which, when executed by the one or more processors, cause performance of a method, comprising:
receiving first sensor data from a first set of sensors of a vehicle and second sensor data from a second set of sensors of the vehicle, the first sensor data representing operation of the vehicle in accordance with a first trajectory, and the second sensor data representing at least one object;
determining that the first trajectory violates a first behavioral rule of a hierarchical plurality of rules of operation of the vehicle based on the first sensor data and the second sensor data, the first behavioral rule having a first priority;
generating a plurality of alternative trajectories for the vehicle based on the first sensor data and the second sensor data, the plurality of alternative trajectories generated using control barrier functions;
identifying a second trajectory from the plurality of alternative trajectories, wherein the second trajectory violates a second behavioral rule of the hierarchical plurality of rules, the second behavioral rule having a second priority less than the first priority; and
responsive to identifying the second trajectory, transmitting a message to a control circuit of the vehicle to operate the vehicle based on the second trajectory.

16. One or more non-transitory storage media storing instructions which, when executed by one or more computing devices, cause performance of a method, comprising:
receiving first sensor data from a first set of sensors of a vehicle and second sensor data from a second set of sensors of the vehicle, the first sensor data representing operation of the vehicle in accordance with a first trajectory, and the second sensor data representing at least one object;
determining that the first trajectory violates a first behavioral rule of a hierarchical plurality of rules of operation of the vehicle based on the first sensor data and the second sensor data, the first behavioral rule having a first priority;
generating a plurality of alternative trajectories for the vehicle based on the first sensor data and the second sensor data, the plurality of alternative trajectories generated using control barrier functions;
identifying a second trajectory from the plurality of alternative trajectories, wherein the second trajectory violates a second behavioral rule of the hierarchical plurality of rules, the second behavioral rule having a second priority less than the first priority; and
responsive to identifying the second trajectory, transmitting a message to a control circuit of the vehicle to operate the vehicle based on the second trajectory.

17. (canceled)

18. The vehicle of claim 15, wherein the at least one processor is located within a planning circuit of the vehicle, and wherein the at least one processor receives the first sensor data and the second sensor data during the operation of the vehicle.

19. The vehicle of claim 15, further comprising adjusting, by the at least one processor, operation of a planning circuit of the vehicle based on the second trajectory, wherein the at least one processor is located on a computer device external to the vehicle, and wherein the at least one processor receives the first sensor data and the second sensor data after the operation of the vehicle.

20. The vehicle of claim 15, wherein the first sensor data comprises at least one of a speed of the vehicle, an acceleration of the vehicle, a heading of the vehicle, an angular velocity of the vehicle, or a torque of the vehicle.

21. The vehicle of claim 15, wherein the second sensor data comprises at least one of an image of the at least one object, a speed of the at least one object, an acceleration of the at least one object, a lateral distance between the at least one object and the vehicle, or other kinematic data.
